(19) United States
(12) Patent Application Publication
(10) Pub. No.: US 2008/0256586 A1
(43) Pub. Date: Oct. 16, 2008

(54) Interactive Television Using Supplementary Information and a Backward Channel Via a Mobile Radio Communication System

(75) Inventors: Klaus Illgner-Fehns, München (DE); Uwe Rauschenbach, Poing (DE); Marcel Wagner, Munich (DE)

Correspondence Address: Staas & Halsey, 1201 New York Avenue NW 7 th Floor, Washington, DC, 20005, US

(73) Assignee: SIEMENS AKTIENGESELLSCHAFT, MUNICH (DE)

(21) Appl. No.: 11/663,294

(22) PCT Filed: Aug. 25, 2005
(86) PCT No.: PCT/EP05/54187

§ 371 Date: Apr. 1, 2008

(30) Foreign Application Priority Data
Sep. 20, 2004 (DE) 10 2004 045 481.7

(51) Int. Cl. H04N 7/173; H04N 5/04

(52) U.S. Cl. 725/118; 348/500; 348/E05.009

(57) ABSTRACT

The invention can advantageously be applied to voting, wherein invitations for voting which influence the current program on the television set TV are transmitted to the mobile radio device MS, to quiz events, wherein the user is afforded the possibility of entering his answers to questions posed into the mobile radio device MS, to spontaneous purchases or TV commerce, wherein the user can order articles that are promoted or presented during the current program, to messaging, wherein the possibility of sending specific contents is afforded, e.g. “send this clip to a friend”, to communities, wherein e.g. a chat is made available with respect to a broadcast, and to gaming, e.g. in the context of a prize game, relating directly to a current program. What is advantageous with regard to purchases or orders is, in particular, that an unambiguous identification or authentication of the user is ensured by means of the mobile radio communication network NET_UMTS.

### CROSS REFERENCE TO RELATED APPLICATIONS

This application is based on and hereby claims priority to PCT Application No. PCT/EP2005/054187 filed on Aug. 25, 2007 and German Application No. 10 2004 045 481.7 filed on Sep. 20, 2004, the contents of which are hereby incorporated by reference.

### BACKGROUND

The invention relates to a method for transmitting information to a terminal and to a television set. The invention furthermore relates to apparatuses for carrying out the method.

The term interactive television denotes television in which information that supplements the customary audiovisual contents or information and hence a possibility for interaction are offered. The supplementary information affords the user the possibility of providing a return message with regard to the content of the television program. Examples of this are teleshopping, in which a user can purchase a product offered on the television, or voting with regard to the further course of a television broadcast, e.g. by choosing candidates in a show.

A user who would like to receive interactive television has to connect a set-top box to the television set for this purpose, which set-top box, in addition to the decoding of the customary audiovisual contents, enables the supplementary information to be represented by the television set. The supplementary information can be displayed by the television set as an alternative to the program schedule otherwise, it can be superimposed on the current program, or else it can be represented in a mode in which both the additional information and a diminished image of the program are visible.

Interactions are possible without the use of set-top boxes e.g. by the supplementary information explicitly drawing attention to the interaction operations, e.g. by displaying an Internet address or telephone number. The user then uses an additional device, such as e.g. his telephone, mobile telephone or PC, to provide a return message. By way of example, an SMS (Short Message Service) can be sent to a number inserted on the television via a mobile radio network. It is also possible for the return message to be effected via the set-top box if the latter is provided with a suitable backward channel, such as e.g. over the Internet via DSL (Digital Subscriber Line).

### SUMMARY

One possible object is to present an efficient method for interactive television. Furthermore, the intention is to present suitable apparatuses for carrying out the method.

The inventors propose that first information, which supplements second information, is transmitted to a terminal for visual display by the terminal in parallel with the replay of the second information by a television set.

The second information may be audio and/or visual information. For the transmission of the second information to the television set, any type of television information transmission is possible, in principle, for example by DVB (Digital Video Broadcast). The terminal to which the first information is transmitted may be, for example, a mobile radio device, a mobile telephone, or a mobile or a stationary computer. The type of transmission of the first information to the terminal depends on the linking of said terminal to one or more communication systems. Thus, the first information may be transmitted for example via radio, in particular via a cellular mobile radio communication system according to the standards GSM or UMTS, via DVB-H (Digital Video Broadcast Handheld, described e.g. in “Digital Video Broadcasting (DVB); Transmission System for Handheld Terminals (DVB-H), ETSI EN 302 304 V1.1.1”) or else over the Internet.

According to the method and devices proposed by the inventors, the first and second information are not displayed and respectively replayed on the same device since the first information is displayed by the terminal, while the second information is replayed by the television set. It is advantageous, in particular, if mutually different, separate transmission networks are used for the transmission of the first and second information, such as, for example, a mobile radio network and a network for the transmission of television information. The first information supplements the second information, that is to say that a relationship in terms of contents exists between the first and second information without the first and second information being identical in terms of contents. Rather, the temporal progression of the first information depends on the temporal progression of the second information. The first information is to be displayed by the terminal in parallel with the replay of the second information by the television set; this means that in each case mutually correlative information portions of the first and second information are displayed and respectively replayed approximately simultaneously and can therefore be perceived by the user of the terminal and the television set.

In one potential development, the first information enables a return message from the user of the terminal in response to the second information. A return message may comprise for example a notification by the user regarding his intended purchase of a product offered, or the casting of a vote. A return message from the user of the terminal is preferably received via a mobile radio channel. For this purpose, it is possible, for example, to use a channel which has been set up by a mobile radio network with which the terminal can communicate, inter alia or specifically for a return message of this type.

In accordance with one advantageous configuration, the first information is transmitted to a plurality of terminals via a broadcast channel or a multicast channel. This enables a resource-saving distribution of the first information.

In one potential development, the first information is transmitted to the terminal in a manner synchronized with the transmission of the second information to the television set. The synchronization can be performed by a device or a communication network which makes the first information available to the terminal.

It is advantageous if the first information is received by the terminal, buffer-stored and displayed in a manner synchronized with the replay of the second information. In this case, the first information need not necessarily be received by the terminal in a manner synchronized with the second information, rather the terminal can delay the display of the first information and thus perform a synchronization with the second information or with the replay of the second information. For this purpose, the first information may be provided with time markers which enable the terminal to determine for how long the first information is buffer-stored.

In a potential configuration, a method for synchronization between the first and the second information is carried out in which a portion of the second information which s recorded by the terminal is received, and a delay time with regard to the first information is determined. The reception and determination are effected by one or more suitable devices of a communication network with which the terminal communicates. The delay time may be for example a time period which is to be complied with prior to the transmission of the first information to the terminal, and/or which is to be complied with prior to the display of the first information by the terminal. The delay time determined may be transmitted to the terminal, if appropriate.

In a potential configuration, a method for synchronization between the first and the second information is carried out in which information about a delay time which is to be complied with prior to the display of the first information by the terminal is transmitted to the terminal from another terminal. It is therefore possible that a delay time determined previously with regard to one terminal is applied with regard to different terminals.

In accordance with one configuration, a method for synchronization between the first and the second information is carried out in which the television set outputs information about a delay time which is to be complied with prior to the display of the first information by the terminal. This information about a delay time may be made available via teletext, for example.

The proposed terminal has a receiver to receive first information, which supplements second information, and a display the visual display of the first information in parallel with the replay of the second information by a television set. In particular, it is possible for the terminal furthermore to have an offset unit to temporally offset visual display of the first information relative to the reception of the first information, and/or a buffer for buffer-storing the received first information prior to the visual display.

The proposed device has a transmitter for transmitting first information, which supplements second information, to a terminal for visual display by the terminal in parallel with the replay of the second information by a television set. The device can be realized by a plurality of interconnected devices. The device may furthermore have: a transmitter for transmitting the first information in a manner synchronized with the second information, and/or a unit for creating and transmitting synchronization information to the terminal, which enables the terminal to effect the synchronized display of the first information with the replay of the second information.

Both the proposed terminal and the proposed device serve in particular for carrying out the method, and this may also apply to the configurations and developments.

### BRIEF DESCRIPTION OF THE DRAWING

These and other objects and advantages of the present invention will become more apparent and more readily appreciated from the following description of the preferred embodiments, taken in conjunction with the accompanying drawing

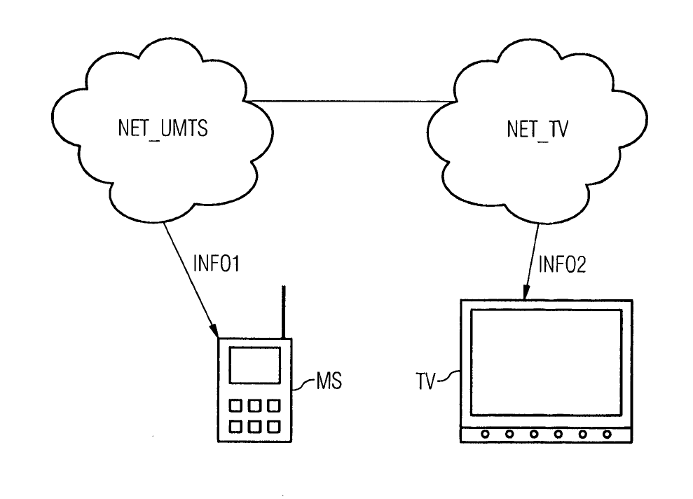

(FIG. 1) which shows two communication systems.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

FIG. 1 shows a television set TV connected to a system NET_TV for the distribution of television information INFO2. The type of distribution of the television information INFO2 is not relevant to the present invention, examples are analog transmission via cable, terrestrial broadcast or satellite, and also digital broadcast via cable (DVB-C, Digital Video Broadcast Cable), terrestrial broadcast (DVB-T, Digital Video Broadcast Terrestrial) or satellite (DVB-S, Digital Video Broadcast Satellite).

FIG. 1 furthermore shows a mobile radio device MS, connected to a mobile radio communication network NET_UMTS via a radio interface. The concrete configuration of the mobile radio communication system is not relevant to the present invention, examples are systems according to the standard GSM (Global System for Mobile Communication), UMTS (Universal Mobile Telecommunications System), DVB-H (Digital Video Broadcast Handheld), DAB (Digital Audio Broadcasting), or else WLANs (Wireless Local Area Network).

Additional or supplementary information INFO1 with respect to the television information INFO2 is sent to the mobile radio device MS by the mobile radio communication network NET_UMTS and displayed by said mobile radio device. The supplementary information INFO1 is information which enables interactive television for the user of the television set TV and the mobile radio device MS. The supplementary information INFO1 is correlated with the television information INFO2 in terms of contents. Consequently, the supplementary information INFO 1 involves contents associated with the television information INFO2, the temporal progression of the supplementary information INFO1 depending on the temporal progression of the television information INFO2. The supplementary information INFO1 may comprise e.g. an Internet page, so that the user can select buttons displayed to him by the input possibilities of the mobile radio device MS. A return message is then effected, if appropriate, via a radio channel made available by the mobile radio communication network NET_UMTS for return messages of this type.

The supplementary information INFO1 may be sent via a point-to-point connection between the mobile radio communication network NET_UMTS and the mobile radio device MS, e.g. via the GPRS (General Packet Radio Service). However, the use of broadcast or multicast messages is advantageous, e.g. via MBMS (Multimedia Broadcast and Multicast Service), or via DVB-H (DVB-H, Digital Video Broadcast Handheld)/CBMS (Convergence of Broadcast and Mobile Services).

The proposed method and apparatuses makes it possible for the TV program, i.e. the television information INFO2, and the associated interaction contents, i.e. the supplementary information INFO1, to be received and represented for a user of interactive television via two devices that are not interconnected, i.e. via the television set TV and the mobile radio device MS. The distribution of the television information INFO2 and of the supplementary information INFO1 is also effected via mutually independent networks, on the one hand via the system NET_TV for the distribution of television information INFO2 and on the other hand via the mobile radio communication network NET_UMTS. The user usually has to carry out a context change if he intends to provide a return message in interactive television. Thus, in accordance with the related art the supplementary information INFO1 is inserted into the television information INFO2 by the creator of the latter and is represented on the television set TV. A return message is then effected by sending an SMS into an inserted telephone number, surfing to an inserted Internet address or sending an email to an inserted email address.

It is advantageous that, the existing TV infrastructure in a user's household can continue to be operated for the use of interactive television services and the value-added services of interactive television can be made available by a mobile radio device without the user having to procure a set-top box.

The television information INFO2 and the supplementary information INFO1 can be synchronized in order to avoid time delays between the replay of the TV content and the interactive content. For this purpose, the supplementary information INFO1 is transmitted to the mobile radio device MS via a mobile radio channel, delayed or buffer-stored with the use of a suitable delay buffer and displayed at the correct, i.e. synchronized, point in time, so that the television information INFO2 and the supplementary information INFO1 that is correlated in terms of contents are perceptible to the user at approximately the same time. The length of the delay time depends on the transmission system used for the television information INFO2. The delay time can be determined in a calibration step, in which case a calibration step of this type has to be carried out only once, in principle, i.e. as adaptation of the mobile radio device MS to the television set TV. If the television set TV can receive the television information INFO2 in different ways, the calibration is to be carried out for each type of dissemination of the television information INFO2. Thus, for example, a satellite transmission causes a signal delay of the television information INFO2 of the order of magnitude of a few seconds. This should be taken into account prior to the display of the supplementary information INFO1 on the mobile radio device MS.

The calibration step may be configured in such a way that the television sound and/or the television picture are/is recorded by the mobile radio device MS and sent to the mobile radio communication network NET_UMTS. The sending may be effected in real time via the voice or video telephony channel, or be provided with a time stamp, which indicates the instant of recording with regard to the internal clock of the mobile radio device MS, by a store-and-forward transmission method such as e.g. MMS (Multimedia Messaging Service). In the mobile radio communication network NET_UMTS, the received sound and/or the received pictures are/is compared with the current television program which the mobile radio communication network NET_UMTS can receive. For this purpose, FIG. 1 depicts a connection between the mobile radio communication network NET_UMTS and the system NET_TV for the distribution of television information. Furthermore, the mobile radio communication network NET_UMTS knows the time period which is required for the transmission of the supplementary information INFO1 from the mobile radio communication network NET_UMTS to the mobile radio device MS. From the knowledge—obtained on account of the sending of the television sound and/or television picture—of the point in time when the television information INFO2 was replayed on the television set TV, the mobile radio communication network NET_UMTS can determine the point in time at which the supplementary information INFO1 is to be displayed by the mobile radio device MS, or alternatively the delay time during which the supplementary information INFO1 is to be buffer-stored by the mobile radio device MS prior to replay. Said point in time or said time period is subsequently communicated to the mobile radio device MS.

If synchronization of this type was carried out between a mobile radio device MS and a television set TV, then the calibration data obtained can also be used with regard to another mobile radio device which is intended to receive supplementary information INFO1 with respect to a program of the same television set TV. For this purpose, they can either be transmitted from mobile radio device to mobile radio device or else be transmitted from the mobile radio communication network NET_UMTS to the further mobile radio device.

Another possibility for a calibration step relates to making available a code for each transmission path of the television information INFO2 on a teletext page of the television set TV, said code being entered into the mobile radio device MS by the user. The mobile radio device can then infer the appropriate delay time from said code. A further possibility relates to the user manually matching the clock of the mobile radio device with the clock running on teletext.

In addition to the case described where the supplementary information INFO1 is buffer-stored by the mobile radio device MS and displayed synchronously with the television information INFO2, it is also possible for the mobile radio communication network NET_UMTS to take account of the delay time by the supplementary information INFO1 being transmitted to the mobile radio device MS in delayed fashion. The mobile radio device MS can then replay the supplementary information INFO1 without a delay.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-11. (canceled)

12. A method for transmitting information, comprising:
transmitting first information, which supplements second information, to a terminal;
receiving the first information;
storing the first information in a buffer; and
displaying the first information at the terminal in a manner synchronized with a replay of second information using a delay time, the second information being replayed by a television set, the delay time depending on a system used for transmitting the second information.

13. The method as claimed in claim 12,
wherein:
the first information enables a return message from the user of the terminal in response to the second information.

14. The method as claimed in claim 13,
comprising further:
receiving a return message from the user of the terminal via a mobile radio channel.

15. The method as claimed in claim 12,
wherein:
the second information is audio and/or visual television information that is transmitted to the television set by a system NET_TV.

16. The method as claimed in claim 12,
wherein
the first information is supplementary information that enables interactive television for the user of the television set and a mobile radio device.

17. The method as claimed in claim 12,
comprising further:
transmitting the first information to a plurality of terminals via a broadcast channel or a multicast channel.

18. The method as claimed in claim 12,
comprising further:
transmitting the first information to the terminal via a unicast channel.

19. The method as claimed in claim 12,
comprising further:
transmitting the first information in synchronization with the transmission of the second information to the television set.

20. The method as claimed in claim 12, comprising further:
synchronizing the first information and the second information by receiving a portion of the second information which is recorded and sent by the terminal and determining the delay time with regard to the first information.

21. The method as claimed in claim 12,
comprising further:
synchronizing the first information and the second information by transmitting information about a delay time to the terminal from another terminal, the information about the delay time being complied with prior to the display of the first information by the terminal.

22. The method as claimed in claim 12,
comprising further:
synchronizing the first information and the second information; and
outputting television set information about the delay time which is to be complied with prior to the display of the first information by the terminal.

23. A terminal comprising:
means for receiving and buffer-storing first information, the first information supplementing second information, and
means for visual display of the first information in parallel with a replay of the second information by a television set,
wherein the first information is displayed in a manner synchronized with the replay of the second information using a delay time, and
wherein the delay time depends on a system used for the transmission of the second information.

24. A device comprising:
means for transmitting first information to a terminal for visual display by the terminal in parallel with a replay of second information by a television set, the first information supplementing the second information, and
means for creating and transmitting synchronization information to the terminal, the synchronization information enabling the terminal to synchronize a display of the first information with the replay of the second information.

25. A method for transmitting information, comprising:
transmitting the first information to a terminal;
storing the first information in a buffer;
transmitting second information to a television set;
providing a delay time depending on a system used for transmitting the second information;
replaying the second information by the television set;
synchronizing the first information with the replay of the second information using the delay time; and
displaying the first information at the terminal during the replay of the second information.

26. The method as claimed in claim 14, comprising further:
transmitting the first information in synchronization with the transmission of the second information to the television set.

27. The method as claimed in claim 26, comprising further:
synchronizing the first information and the second information by receiving a portion of the second information which is recorded and sent by the terminal and determining the delay time with regard to the first information.

28. The method as claimed in claim 27, comprising further:
synchronizing the first information and the second information by transmitting information about a delay time to the terminal from another terminal, the information about the delay time being complied with prior to the display of the first information by the terminal.

29. The method as claimed in claim 28, comprising further:
outputting television set information about the delay time which is to be complied with prior to the display of the first information by the terminal.
